(19) United States
(12) Patent Application Publication
(10) Pub. No.: US 2018/0290360 A1
(43) Pub. Date: Oct. 11, 2018

(54) LIQUID INJECTION MOLDING APPARATUS

(71) Applicant: Mold-Masters (2007) Limited, Georgetown (CA)

(72) Inventor: Alexander BERLIN, Mississauga (CA)

(21) Appl. No.: 15/481,123

(22) Filed: Apr. 6, 2017

(51) Int. Cl. B29C 45/20; B29C 45/03; B29C 45/17; B29C 45/26

(52) U.S. Cl. CPC B29C 45/20; B29C 45/2608; B29C 45/1775; B29C 45/03

(57) ABSTRACT

A nozzle for use in a liquid injection molding apparatus is provided. The nozzle comprising: a body defining a first channel and a second channel substantially transverse to and crosses the first channel. The first channel is for conveying a moldable liquid through the nozzle. The nozzle further comprising a rod including a groove around a circumference of the rod. The rod is reciprocable within the second channel between a first position with the groove positioned outside of the first channel preventing the moldable liquid from flowing through the nozzle and a second position with the groove in the first channel permitting the moldable liquid to flow through the nozzle via the groove.

### FIELD

The invention relates generally to a liquid injection molding apparatus and, in particular, to a nozzle for use in a liquid injection molding apparatus.

### BACKGROUND

Liquid injection molding injects a moldable liquid into a mold to form a solid article. The moldable liquid is a mixture such as thermosets or liquid silicone rubber (LSR) that is in the liquid state at room temperature and when heated cures into a solid. Some mixtures can also cure at room temperature if left at room temperature over a period of time.

Challenges exist in controlling the dispensing of the moldable liquid from an injector into a mold assembly.

### BRIEF SUMMARY

In an illustrated embodiment, a nozzle for use in a liquid injection molding apparatus is provided. The nozzle comprising: a body defining a first channel and a second channel substantially transverse to and crosses the first channel. The first channel is for conveying a moldable liquid through the nozzle. The nozzle further comprises a rod including a groove around a circumference of the rod. The rod is reciprocable within the second channel between a first position with the groove positioned outside of the first channel preventing the moldable liquid from flowing through the nozzle and a second position with the groove in the first channel permitting the moldable liquid to flow through the nozzle via the groove.

The nozzle can further comprise an actuator for reciprocating the rod.

The nozzle can further comprise a first and second seals, both seals are annular, surrounding the second channel, and radially spaced apart relative to the first channel. The rod extends through at least the first seal and is reciprocable in both seals. Both seals are dimensioned to engage the rod to reduce the amount of the moldable liquid from exiting the first channel via the second channel.

The nozzle can further comprise a third seal. The third seal is annular. The rod extends through and is reciprocable within the third seal. The first seal is located between the third seal and the first channel.

The first and second seals can be u-shaped seals. Each seal having a cross-section formed by a base with a first and second legs projecting from opposite sides of the base forming a gap between the legs.

The first leg can be adjacent to the rod. The first and second seals include an energizer located in the gap to urge the first leg towards the rod.

The first leg can include a lip projecting towards and engaging the rod.

The energizer can be an o-ring.

A cross-section of the groove can include a lead-in portion at an opening of the groove.

The cross-section of the groove can further include a round portion forming a closed end of the groove.

The rod can include a chamfered end.

The actuator can be a pneumatic actuator including a chamber and a piston housed in the chamber. The piston is reciprocable within the chamber and connected to the rod for moving the rod between the first and second positions.

The nozzle can further comprise a fourth annular seal. The rod extends through and is reciprocable within the fourth seal. The fourth seal is located between the piston and the third seal.

The actuator can be an electric linear actuator including a motor and an anti-rotation mechanism.

The motor can be located adjacent to the body of the nozzle.

In another illustrated embodiment, a liquid injection molding apparatus is provided. The liquid injection molding apparatus comprising: a mold assembly; a clamping unit; an injector; and a nozzle attached to the injector. The nozzle comprising: a body defining a first channel and a second channel substantially transverse to and crosses the first channel. The first channel is for conveying a moldable liquid through the nozzle. The nozzle further comprises a rod including a groove around a circumference of the rod. The rod is reciprocable within the second channel between a first position with the groove positioned outside of the first channel preventing the moldable liquid from flowing through the nozzle and a second position with the groove in the first channel permitting the moldable liquid to flow through the nozzle via the groove.

The liquid injection molding apparatus can further comprise an actuator an actuator for reciprocating the rod.

### BRIEF DESCRIPTION OF THE DRAWINGS

FIG. 1 is a schematic view of a liquid injection molding apparatus according to an embodiment of the present application;

FIG. 2 is a side view of an injector of FIG. 1 according to an embodiment of the present application;

FIG. 3 is a top view of the injector of FIG. 2;

FIG. 4 is a perspective view of a nozzle of FIG. 2 according to an embodiment of the present application;

FIG. 5 is a section view of the nozzle of FIG. 4, taken along the line A-A of FIG. 4, with the rod in the first position;

FIG. 6 is a section view of the nozzle of FIG. 4, taken along the line A-A of FIG. 4, with the rod in the second position;

FIG. 7 is a section view of the rod of FIG. 5 and FIG. 6;

FIG. 8 is a partial section view of a nozzle of FIG. 2 according to another embodiment of the present application; and

FIG. 9 is a perspective view of a nozzle of FIG. 2 according to yet another embodiment of the present application.

### DETAILED DESCRIPTION

Specific embodiments of the present application are now described with reference to the figures. The following detailed description is merely exemplary in nature and is not intended to limit the concepts and uses of the concepts. Furthermore, there is no intention to be restricted by any expressed or implied theory in the present disclosure. In the description, “downstream” is used with reference to the direction of the moldable liquid flow from an injector to a mold cavity, and also with reference to the order of components, or features thereof, through which the mold material flows from the injector to the mold cavity, whereas “upstream” is used with reference to the opposite direction.

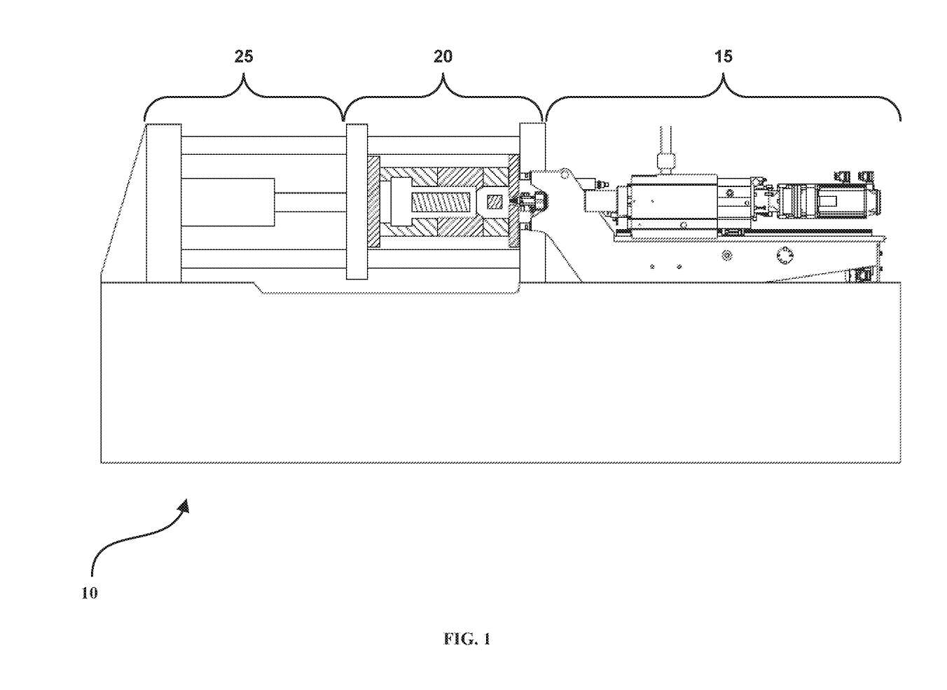

FIG. 1 is a schematic view of a liquid injection molding apparatus 10 including an injector 15, a mold assembly 20, and a clamping unit 25. In operation, after clamping unit 25 clamps mold assembly 20 shut, injector 15 injects a moldable liquid (not shown) into mold assembly 20. After the moldable liquid cures into a solid article (not shown), clamping unit 25 opens mold assembly 20 to release the newly formed solid article. The process is subsequently repeated to create the next solid article.

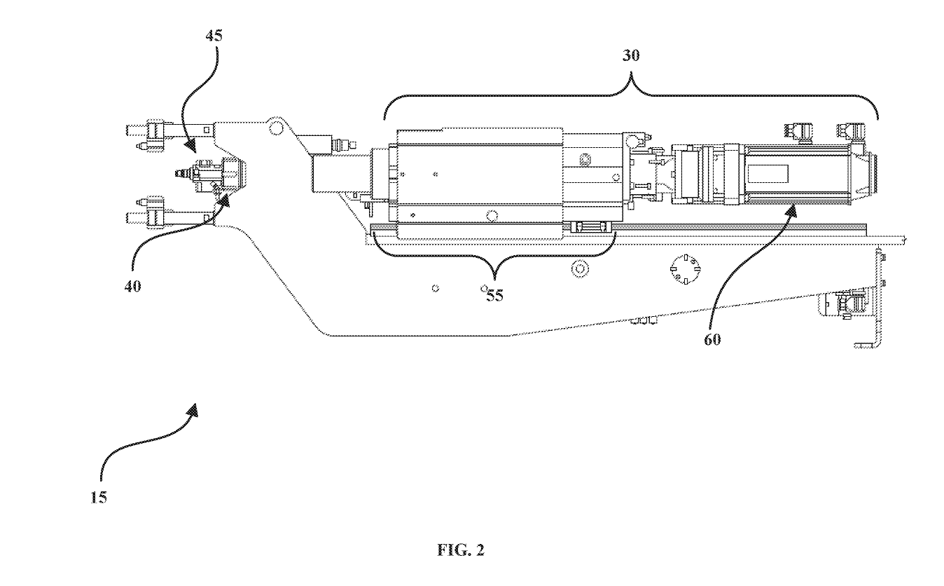

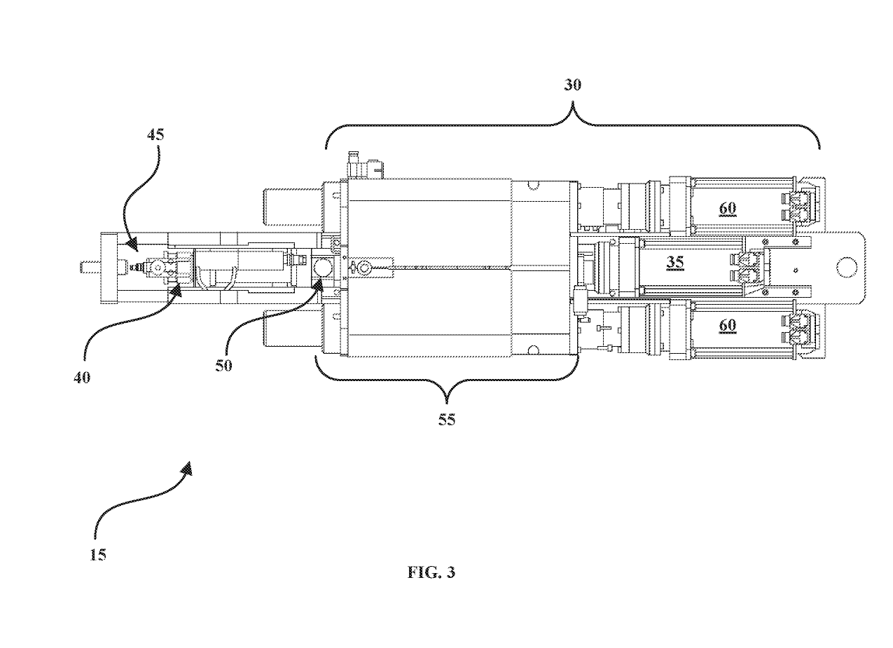

FIG. 2 and FIG. 3 illustrate an embodiment of injector 15, which includes a linear actuator 30 and a feed screw motor 35, both coupled to a feed screw (not shown) housed in a barrel 40 for reciprocating and rotating, respectively, the feed screw within barrel 40. Injector 15 includes a nozzle 45 and an input valve 50, nozzle 45 for controlling the moldable liquid dispensed from injector 15 into mold assembly 20 and input valve 50 for receiving the moldable liquid from a source (not shown) into barrel 40. Linear actuator 30 includes a drive mechanism 55 and at least one motor 60. Drive mechanism 55 is coupled to motor 60 and the feed screw to convert the rotational motion of motor 60 into a linear motion, which is imparted onto the feed screw to reciprocate the feed screw within barrel 40. Linear actuator 30 moves the feed screw downstream to inject the moldable liquid into mold assembly 20 through nozzle 45 and retracts the feed screw upstream to reload the feed screw with the moldable liquid for the subsequent injection. (Depending on the application of injector 15, one or two motor 60 may be used and feed screw motor 35 may be used to rotate the feed screw to stir the moldable liquid within barrel 40.)

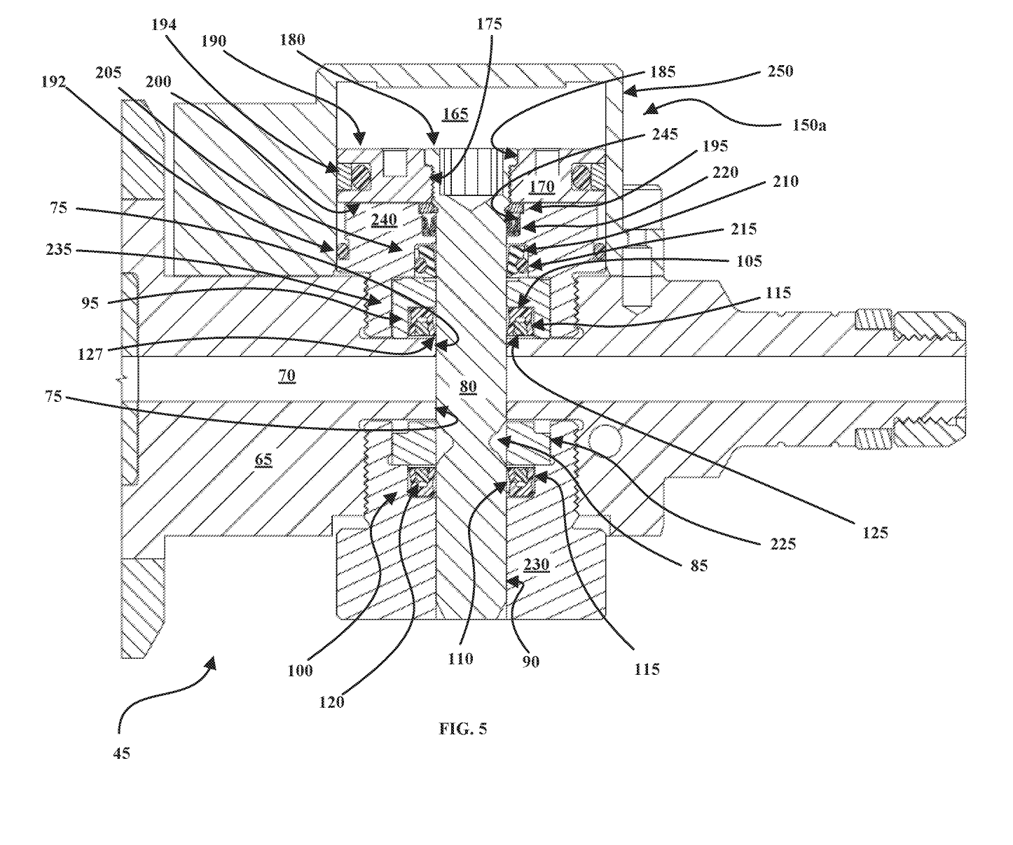

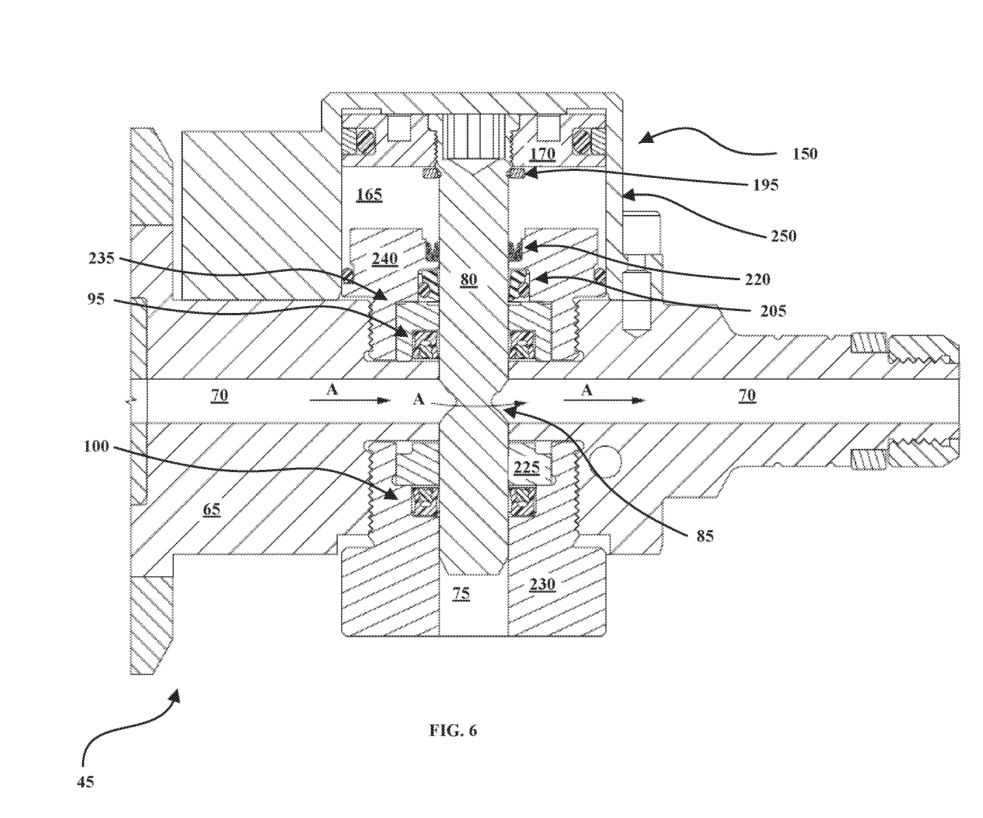

Referring to FIG. 5 and FIG. 6, nozzle 45 includes a body 65 defining a first channel 70 and a second channel 75 substantially transverse to and crosses first channel 70. First channel 70 is for conveying a moldable liquid through nozzle 45. Nozzle 45 includes a rod 80 having a groove 85 around a circumference 90 of rod 80. Rod 80 is reciprocable within second channel 75 between a first position (see FIG. 5) with groove 85 positioned outside of first channel 70 preventing the moldable liquid from flowing through nozzle 45 and a second position (see FIG. 6) with groove 85 in first channel 70 permitting the moldable liquid to flow through nozzle 45 via groove 85 (as shown by arrows A in FIG. 6).

Nozzle 45 may include a first and second seals 95, 100, both seals are annular, surrounding second channel 75, and radially spaced apart relative to first channel 70 with rod 80 extending through at least first seal 95 and reciprocable within both seals 95, 100. Both seals 95, 100 are dimensioned to engage rod 80 to reduce the amount of the moldable liquid from exiting first channel 70 via second channel 75. First and second seals 95, 100 may be u-shaped seals, each seal having a cross-section formed by a base 105 with a first and second legs 110, 115 projecting from opposite sides of base 105 forming a gap 120 between legs 110, 115. Seals 95, 100 are positioned in nozzle 45 with the opening of gap 120 facing first channel 70 (i.e., with base 105 distal from first channel 70). Seals 95, 100 may include an energizer 125, such as an o-ring, located in gap 120 to urge first leg 110 towards rod 80. First leg 110 may include a lip 127 projecting towards and engaging rod 80. (Depending on the application of liquid injection molding apparatus 10, the cross-section of energizer 125 can be circular, substantially square, or other functionally equivalent shape.)

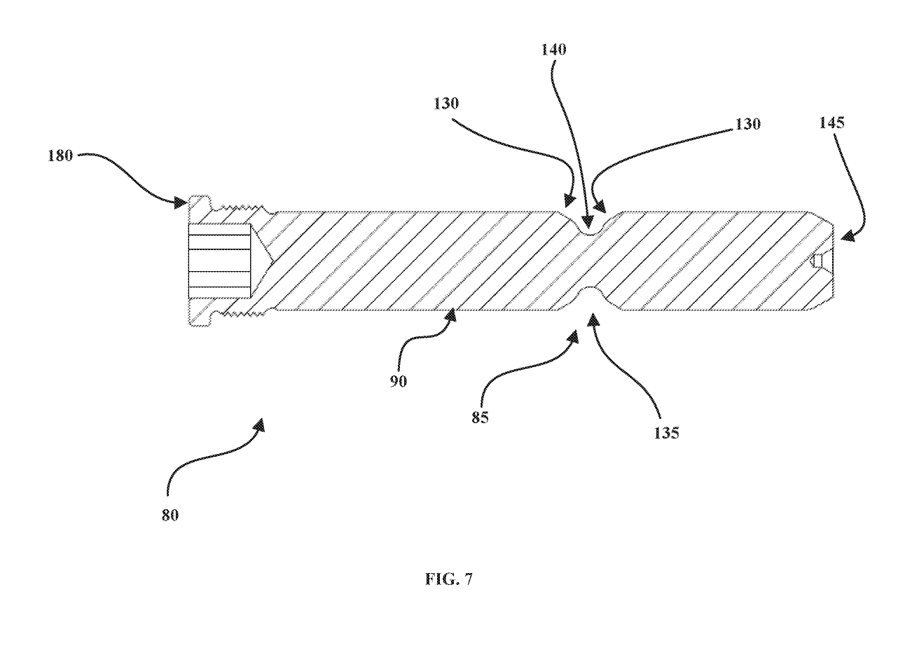

Referring to FIG. 5, FIG. 6, and FIG. 7, groove 85 may have a cross-section that includes a lead-in portion 130 at an opening 135 of groove 85 and a round portion 140 forming a closed end of groove 85. Groove 85 may include a chamfered end 145. The lead-in portions 130 and chamfered end 145 may help reduce risks of damaging seals, engaged to rod 80, during assembly or operation of nozzle 45.

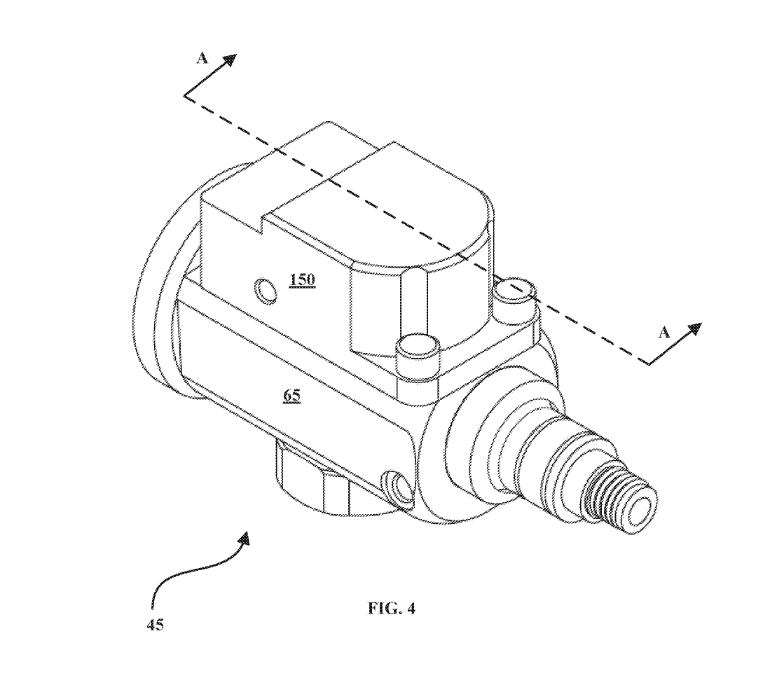

Nozzle 45 may include an actuator 150 for reciprocating rod 80 between the first position (see FIG. 5) and second position (see FIG. 6). In the embodiment illustrated by FIG. 4, FIG. 5, and FIG. 6, the linear actuator is a pneumatic actuator, which includes a chamber 165 and a piston 170 housed in chamber 165. Piston 170 is reciprocable within chamber 165 and is connected to rod 80 for moving rod 80 between the first and second positions. In the illustrated embodiment of FIG. 5 and FIG. 6, rod 80 is connected to piston 170 by having rod 80 inserted through a central bore 175 of piston 170 and retaining piston 170 between a flange 180 seated in a countersink 185 at an end 190 of piston 170 and a retaining ring 195 clamped to rod 80 abutting an end 200 of piston 170 opposite of end 190. Applicable seals (e.g., o-rings 192, 194) are included to localize air within specific regions of chamber 165. In the illustrated embodiments, when rod 80 is in the first position, first channel 70 is located between groove 85 and actuator 150. However a person of relevant ordinary skill in the art would appreciate that in the first position, nozzle 45 can be configured to position groove 85 between first channel 70 and actuator 150.

Nozzle 45 may include a third seal 205, third seal 205, an annular seal, positioned between piston 170 and first seal 95 (i.e., first seal 95 is positioned between third seal 205 and first channel 70). Rod 80 extends through and is reciprocable within third seal 205. In the illustrated embodiment, third seal 205 includes an annular body 210 and an energizer 215 (e.g., an o-ring) surrounding annular body 210 to urge annular body 210 towards rod 80.

Nozzle 45 may include a fourth seal 220, an annular seal, to reduce the amount air leaking out of chamber 165 via second channel 75. In the illustrated embodiment of FIG. 5 and FIG. 6, fourth seal 220 is a spring loaded u-shaped seal (i.e., the seal has a first and second legs projecting from opposite sides of a base forming a gap between the first and second legs, v-shaped metal springs are housed in the gap to urge the first and second legs apart). However a person of ordinary relevant skills in the art would appreciate that fourth seal 220 can be other types of seals such as o-rings. Fourth seal 220 is positioned between piston 170 and third seal 205 with the opening of the gap facing away from first channel 70.

Various means may be used to fix seals 95, 100, 205, and 220, and rod 80 in their respective position and orientation; the illustrated embodiments provide an example of such a means. A first spacer 225 locates second seal 100 at a predetermined distance from first channel 70. A first nut 230 threadably secures second seal 100 and first spacer 225 to body 65 and partially defines second channel 75. A second spacer 235 locates third seal 205 at a predetermined distance from first channel 70 and retains first seal 95 in a predetermined position. A second nut 240 threadably secures first seal 95 and second spacer 235 to body 65 and partially defines second channel 75. In the illustrated embodiment of FIG. 5 and FIG. 6, second nut 240 houses fourth seal 220 in a countersink 245 and a cap 250 defines chamber 165.

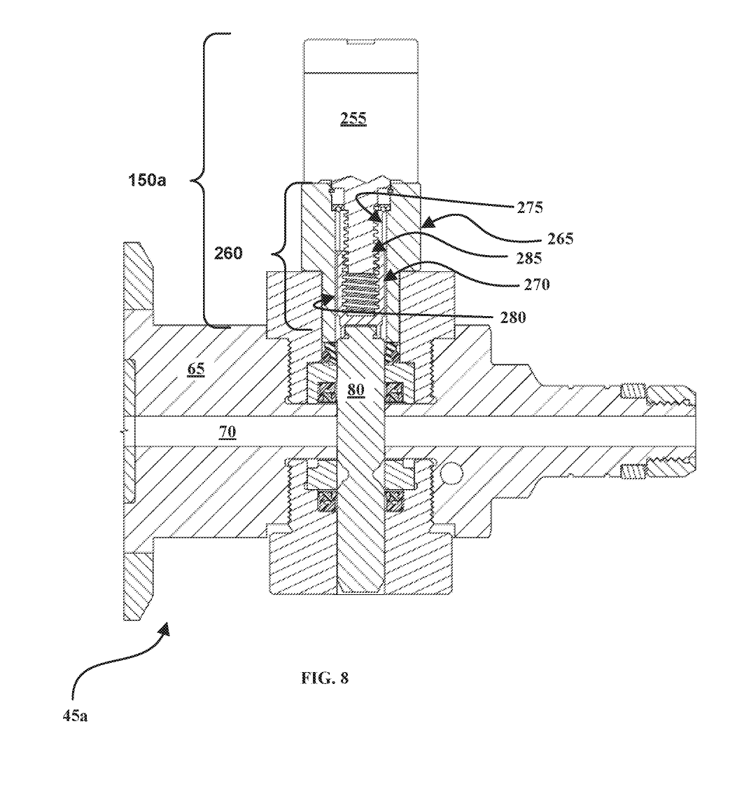

FIG. 8 illustrates another embodiment of nozzle 45 generally indicated by 45a. Nozzle 45a includes an electric linear actuator rather than a pneumatic actuator in the embodiment illustrated by FIG. 5 and FIG. 6. Elements common to both embodiments bear the same reference characters. Elements of the embodiment illustrated in FIG. 8 that are variants of their counterparts of the embodiment of FIG. 5 and FIG. 6 bear the same reference character as their counterpart except with letter “a” appended to the reference character. Actuator 150a includes a motor 255 and an anti-rotation mechanism 260 coupling motor 255 to rod 80. Anti-rotation mechanism 260 converts rotational motion of motor 255 into a linear motion which is imparted onto rod 80 to reciprocate rod 80 within second channel 75. Anti-rotation mechanism 260 includes a restrictor 265 and a captive member 270, both arranged for converting a rotational motion of motor 255 to a linear motion of captive member 270. In the embodiment illustrated in FIG. 8, restrictor 265 defines a spline channel 275 and captive member 270 includes a spline shaft 280 corresponding to and engaging spline channel 275 to enable captive member 270 to be axially but not rotationally movable relative to restrictor 265. Motor 255 includes a drive shaft 285 coupled to captive member 270 such that, when motor 255 rotates drive shaft 285, drive shaft 285 rotates within captive member 270. Because restrictor 265 prevents captive member 270 from rotating, captive member 270 moves linearly within restrictor 265. Captive member 270 is attached to rod 80 to impart linear motion of captive member 270 onto rod 80.

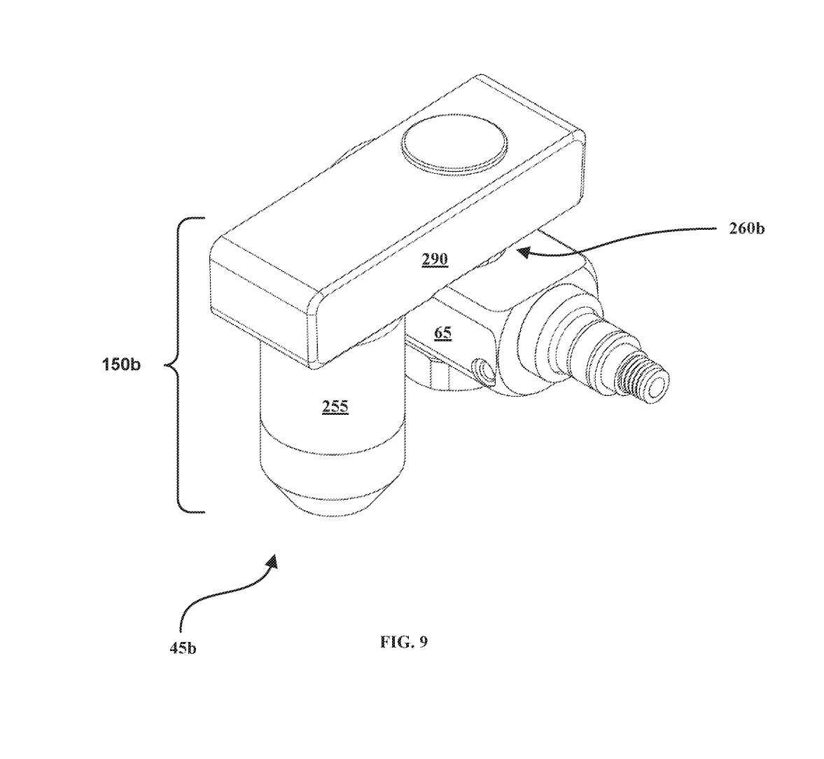

FIG. 9 illustrates another embodiment of nozzle 45 generally indicated by 45b. Nozzle 45b includes an electric linear actuator with its motor 255 located adjacent to body 65 rather than aligned with rod 80, as illustrated by FIG. 8. Elements common to both embodiments bear the same reference characters, elements of the embodiment illustrated in FIG. 9 that are variants of their counterparts of the embodiment of FIG. 8 bear the same reference character as their counterpart except with letter “b” appended to the reference character. Actuator 150b includes a motor 255 and an anti-rotation mechanism 260b, and a transmission assembly 290 transmitting rotational motion of motor 255 to anti-rotation mechanism 260b via for example, a belt and pulley assembly (not shown). Anti-rotation mechanism 260b can be structurally similar to that of Anti-rotation mechanism 260 but modified to couple with transmission assembly 290 rather than the draft shaft of motor 255.

In operation, rod 80 is moved, via any of the previously described actuators (i.e., actuator 150, 150a, and 150b), to the second position (see FIG. 6), with groove 85 in first channel 70. Linear actuator 30 advances the feed screw downstream to urge the moldable liquid in barrel 40 to travel around rod 80 via groove 85. When the desired amount of the moldable liquid has entered mold assembly 20, rod 80 is moved, via any of the previously described actuators (i.e., actuator 150, 150a, and 150b), to the first position (see FIG. 5) with groove 85 outside of first channel 70 preventing the moldable liquid from flowing through nozzle 45. To prepare for the subsequent injection, linear actuator 30 retracts the feed screw to reload the feed screw with the moldable liquid.

While various embodiments according to the present application have been described above, it should be understood that they have been presented by way of illustration and example only, and not limitation. It will be apparent to persons of ordinary relevant skill in the relevant art that various changes in form and detail can be made therein without departing from the scope of the invention. For example, actuators 150, 150a, 150b can be integral with nozzle 45, 45a, 45b or separate from nozzle 45, 45a, 45b. It will also be understood that each feature of each embodiment discussed herein, may be used in combination with the features of any other embodiment. Thus, the breadth and scope of the present invention should not be limited by the above-described exemplary embodiments, but should be defined only in accordance with the appended claims and their equivalents.

What is claimed is:

1. A nozzle for use in a liquid injection molding apparatus, the nozzle comprising:
a body defining a first channel and a second channel substantially transverse to and crosses the first channel, the first channel for conveying a moldable liquid through the nozzle; and
a rod including a groove around a circumference of the rod, the rod reciprocable within the second channel between a first position with the groove positioned outside of the first channel preventing the moldable liquid from flowing through the nozzle and a second position with the groove in the first channel permitting the moldable liquid to flow through the nozzle via the groove.

2. The nozzle of claim 1 further comprising: an actuator for reciprocating the rod.

3. The nozzle of claim 1 or 2 further comprising: a first and second seals, both seals are annular, surrounding the second channel, and radially spaced apart relative to the first channel, the rod extending through at least the first seal and reciprocable in both seals, both seals dimensioned to engage the rod to reduce the amount of the moldable liquid from exiting the first channel via the second channel.

4. The nozzle of claim 3 further comprising: a third seal, the third seal is annular, the rod extending through and reciprocable within the third seal, the first seal located between the third seal and the first channel.

5. The nozzle of claim 4, wherein the first and second seals are u-shaped seals, each seal having a cross-section formed by a base with a first and second legs projecting from opposite sides of the base forming a gap between the legs.

6. The nozzle of claim 5, wherein the first leg is adjacent to the rod, the first and second seals include an energizer located in the gap to urge the first leg towards the rod.

7. The nozzle of claim 6, wherein the first leg includes a lip projecting towards and engaging the rod.

8. The nozzle of claim 7, wherein the energizer is an o-ring.

9. The nozzle of claim 4, wherein a cross-section of the groove includes a lead-in portion at an opening of the groove.

10. The nozzle of claim 9, wherein the cross-section of the groove further includes a round portion forming a closed end of the groove.

11. The nozzle of claim 10, wherein the rod includes a chamfered end.

12. The nozzle of claim 4, wherein the actuator is a pneumatic actuator including a chamber and a piston housed in the chamber, the piston reciprocable within the chamber and connected to the rod for moving the rod between the first and second positions.

13. The nozzle of claim 12 further comprising: a fourth annular seal, the rod extending through and reciprocable within the fourth seal, the fourth seal located between the piston and the third seal.

14. The nozzle of claim 4, wherein the actuator is an electric linear actuator including a motor and an anti-rotation mechanism.

15. The nozzle of claim 14, wherein the motor is located adjacent to the body of the nozzle.

16. A liquid injection molding apparatus comprising:
a mold assembly;
a clamping unit;
an injector; and
a nozzle attached to the injector, the nozzle comprising:
a body defining a first channel and a second channel substantially transverse to and crosses the first channel, the first channel for conveying a moldable liquid through the nozzle; and
a rod including a groove around a circumference of the rod, the rod reciprocable within the second channel between a first position with the groove positioned outside of the first channel preventing the moldable liquid from flowing through the nozzle and a second position with the groove in the first channel permitting the moldable liquid to flow through the nozzle via the groove.

17. The liquid injection molding apparatus of claim 16 further comprising: an actuator an actuator for reciprocating the rod.

18. The liquid injection molding apparatus of claim 16 or 17, wherein the nozzle further comprises a first and second seals, both seals are annular, surrounding the second channel, and radially spaced apart relative to the first channel, the rod extending through at least the first seal and reciprocable in both seals, both seals dimensioned to engage the rod to reduce the amount of the moldable liquid from exiting the first channel via the second channel.

19. The liquid injection molding apparatus of claim 18, wherein the nozzle further comprises a third annular seal, the rod extending through and reciprocable within the third seal, the first seal located between the third seal and the first channel.

20. The liquid injection molding apparatus of claim 19, wherein the first and second seals are u-shaped seals, each seal having a cross-section formed by a base with a first and second legs projecting from opposite sides of the base forming a gap between the legs.
